(19) United States
(12) Patent Application Publication
(10) Pub. No.: US 2024/0409804 A1
(43) Pub. Date: Dec. 12, 2024

(54) SCALE INHIBITOR FLUID AND METHOD FOR INHIBITING SCALE FORMATION

(71) Applicant: SAUDI ARABIAN OIL COMPANY, Dhahran (SA)

(72) Inventors: Jian Hou, Beijing (CN); Ming Han, Dhahran (SA); Tao Chen, Dhahran (SA); Mohammed A. Bataweel, Dhahran (SA); Xuan Zhang, Beijing (CN)

(73) Assignee: SAUDI ARABIAN OIL COMPANY, Dhahran (SA)

(21) Appl. No.: 18/809,629

(22) Filed: Aug. 20, 2024

Related U.S. Application Data
(62) Division of application No. 17/723,835, filed on Apr. 19, 2022.

(51) Int. Cl. C09K 8/528; C09K 8/584; C09K 8/84

(52) U.S. Cl. CPC C09K 8/528; C09K 8/584; C09K 8/84

(57) ABSTRACT

A scale inhibitor fluid includes 0.001 ppm to 100 ppm of a phosphonate compound, 20 ppm to 400 ppm of a cation-containing surfactant, and an aqueous fluid. The cation-containing surfactant includes at least one of a single positively charged cation-containing surfactant, a double positively charged cation-containing surfactant and a zwitterionic cation-containing surfactant. A method for inhibiting scale formation in a wellbore includes introducing a phosphonate compound, a cation-containing surfactant and an aqueous fluid to the wellbore to produce a scale inhibitor fluid.

### BACKGROUND

Scale formation in oil and gas extraction operation occurs when various fluids including a hydrocarbon mixture, a fluid in the subterranean formation (“formation fluid”) and a fluid used for drilling and extraction operation (“drilling fluid”, “injection fluid”) come in contact with each other during the operation, and some compounds contained in the fluids react to form insoluble precipitates. Commonly formed scale may include, but is not limited to, calcium carbonate, magnesium carbonate and calcium sulfate. Such scale formation may decrease the permeability of the formation, restrict the fluid flow through an oil and gas wellbore (“wellbore”) and various portion of an oil and gas extraction system, such as drill pipes, and cause issues in production equipment, negatively affecting the well productivity and associated production cost. The severity of scale formation is partially determined by the wellbore and reservoir conditions including temperature, and pressure, and dissolved ion types and concentrations in the fluids.

Conventionally, the scale formation is controlled by the use of scale inhibitors, and a multitude of scale inhibitors have been developed and commercialized. Scale inhibitors generally prevent or retard the scaling process by sequestrating scale-forming cations or through threshold inhibition, nucleation inhibition, crystal distortion and/or dispersion mechanisms. Conventional scale inhibitor may include polyphosphonates, phosphonates, polycarboxylic acid and polyelectrolytes. However, conventional scale inhibitors are often ineffective in preventing the scale formation in a manner required or desired in the extraction operation, particularly in high temperature, high salinity environment, and at a low scale inhibitor dosage. Accordingly, there exists a need for continuing improvement of the scale inhibitor for oil and gas extraction operation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate generally to a scale inhibitor fluid. The scale inhibitor fluid may include 0.001 ppm to 100 ppm of a phosphonate compound, 20 ppm to 400 ppm of a cation-containing surfactant, and an aqueous fluid. The cation-containing surfactant may include at least one of a single positively charged cation-containing surfactant, a double positively charged cation-containing surfactant and a zwitterionic cation-containing surfactant.

In another aspect, embodiments disclosed herein relate generally to a method for inhibiting scale formation in a wellbore. The method may include introducing a phosphonate compound, a cation-containing surfactant and an aqueous fluid to the wellbore to produce a scale inhibitor fluid. The concentration of the phosphonate compound in the scale inhibitor fluid may range from 0.001 ppm to 100 ppm, and the concentration of the cation-containing surfactant in the scale inhibitor fluid may range from 20 ppm to 400 ppm. The cation-containing surfactant may include at least one of a single positively charged cation-containing surfactant, a double positively charged cation-containing surfactant and a zwitterionic cation-containing surfactant.

Other aspects and advantages of the claimed subject matter will be apparent from the following description and the appended claims.

### DETAILED DESCRIPTION

The present disclosure generally relates to a scale inhibitor fluid for subterranean oil and gas extraction operation, and a method for inhibiting scale formation. The scale inhibitor fluid provides improved scale inhibition properties in an environment that includes high temperature and high salinity conditions. The scale inhibitor fluid also provides such improved properties while keeping the phosphonate concentration substantially low, contributing to the overall cost benefit provided by the scale inhibitor fluid. The scale inhibitor fluid may provide effective scale inhibition properties in continuous injection and squeeze treatment operations.

In one aspect, embodiments herein relate to a scale inhibitor fluid comprising 100 ppm or less of a phosphonate compound, 20 ppm to 400 ppm of a cation-containing surfactant and an aqueous fluid.

### Phosphonate Compound

In one or more embodiments, the scale inhibitor fluid may comprise a phosphonate compound. The phosphonate compound acts as a scale inhibitor by combining with a scale-forming cations in a fluid, such as calcium ion, to form a complex of the phosphonate compound and the scale-forming cation, in the fluid, reducing the amount of scale-forming cations in the fluid. Furthermore, the phosphonate compound may adsorb on the surface of micro-crystal of formed scale by static force, preventing or retarding further growth of the micro-crystal.

In one or more embodiments, the scale inhibitor fluid may comprise the phosphonate compound in an amount ranging from about 0.001 to 100 ppm, such as a lower limit selected from any one of 0.001, 0.01, 0.05, 0.1, 0.5, 1, 2, 3, 4, 5, 10, 20, 30 ppm, to an upper limit selected from any one of 50, 60, 70, 80, 90 100 ppm, where any lower limit may be paired with any upper limit.

In one or more embodiments, the phosphonate compound may be any conventionally available phosphonate compounds which includes phosphonate scale inhibitors. In one or more embodiments, the phosphonate compound may be a nitrogen-containing phosphonate compound. In one or more embodiments, the nitrogen-containing phosphonate compound may be, but is not limited to, amino trimethylene phosphonic acid (ATMP), diethylene triamine penta(methylene phosphonic acid) (DETPMP), bis(hexamethylene triamine penta(methylene phosphonic acid)) (BHMT) and hydroxyethylamino-di(methylene phosphoric acid) (MEA), similar nitrogen containing phosphonates, and a combination thereof.

In one or more embodiments, the phosphonate compound may be an organophosphorus compound containing at least one of C—PO(OH)₂ and C—PO(OR)₂ groups, where R may be alkyl or aryl group. In one or more embodiments, the phosphonate compound may be a phosphonate salt which includes a phosphonate salt, but it not limited to, having one of the following structure: C—PO(OH)(ONa), C—PO(ONa)₂, C—PO(OH) (OK) and C—PO(OK) 2. In one or more embodiments, the phosphonate compound may be a combination of any of the phosphonate compounds mentioned above.

### Cation-Containing Surfactant

In one or more embodiments, the scale inhibitor fluid may comprise a cation-containing surfactant. The cation-containing surfactant refers to a quaternary ammonia compounds with positively charged moieties and an alkyl hydrophobic chain. The cation-containing surfactant may be capable of forming micelles at a very low concentration in a fluid having high salinity. The total dissolved salts of such high salinity fluid may range from 50,000 ppm to 200,000 ppm. The cation-containing surfactant may increase the solubility of the micro-crystals of formed scale, which prevents or reduces the growth of the micro-crystals.

In one or more embodiments, the cation-containing surfactant may include at least one of a single positively charged cation-containing surfactant, a double positively charged cation-containing surfactant and a zwitterionic cation-containing surfactant. A single positively charged cation-containing surfactant refers to a cation-containing surfactant containing one positively charged moiety. Examples of a single positively charged cation-containing surfactant may be represented by the following formulas:

R—N⁺(CH₃)₃·X⁻

R—N⁺(CH₂CH₃)₃·X⁻

R—N⁺(CH₂CH₃)₂(CH₃)·X⁻

R—N⁺(CH₂CH₃)(CH₃)₂·X⁻

where R is a linear or branched alkyl hydrocarbon comprising 6 to 18 carbons and may contain no or one carbon double bond (C═C), and X is a halogen ion including Cl, Br and I.

In one or more embodiments, the single positively charged cation-containing surfactant may include dodecyltrimethylammonium bromide (“DTAB”) represented by the formula: C₁₂N⁺(CH₃)₃·Br⁻) and cetyltrimethylammonium bromide (“CTAB”) represented by the formula: C₁₆N⁺(CH₃)₃·Br⁻.

A double positively charged cation-containing surfactant refers to a cation-containing surfactant containing two positively charged moieties. Examples of a double positively charged cation-containing surfactant may be represented by the following formulas:

R—N⁺(CH₃)₂—R₁—N⁺(CH₃)₃·2X⁻

R—N⁺(CH₃)₂—R₁—N⁺(CH₂CH₃)₃·2X⁻

R—N⁺(CH₃)₂—R₁—N⁺(CH₂CH₃)(CH₃)₂·2X⁻

R—N⁺(CH₃)₂—R₁—N⁺(CH₂CH₃)₂(CH₃)·2X⁻

where R is a linear or branched alkyl hydrocarbon comprising 6 to 18 carbons and may contain no or one carbon double bond, R₁ is a linear alkyl hydrocarbon comprising 2 to 5 carbons which may optionally be connected to a hydroxyl group, and X⁻ is a halogen ion including Cl, Br or I.

In one or more embodiments, the double positively charged cation-containing surfactant may include a compound represented by the formula: C₁₈N⁺(CH₃)₂—CH₂—CH(OH)—CH₂—N⁺(CH₃)₂·2Cl⁻(“BCS”).

A zwitterionic cation-containing surfactant refers to a cation-containing surfactant containing both positively charged and negatively charged moieties. The negatively charged moiety of a zwitterionic cation-containing surfactant may include, but is not limited to, a carboxyl group and a sulfonate group. Examples of a zwitterionic cation-containing surfactant may be represented by the following formulas:

R—N⁺(CH₃)₂—R₁—SO₃⁻

R—N⁺(CH₃)₂—R₁—COO⁻

where R is a linear or branched alkyl hydrocarbon comprising 6 to 18 carbons and may contain no or one carbon double bond, and R₁ is a linear alkyl hydrocarbon comprising 2 to 5 carbons which may optionally be connected to a hydroxyl group.

In one or more embodiments, the zwitterionic cation-containing surfactant may include 3-(N,N-dimethylmyristylammonio) propanesulfonate (“SB3-14”) represented by the formula: C₁₄N⁺(CH₃)₂—CH₂—CH₂—SO₃⁻.

In one or more embodiments, the scale inhibitor fluid may include one or more cation-containing surfactant. In the case that the scale inhibitor fluid contains a plurality of cation-containing surfactants, the plurality of cation-containing surfactants may be a combination of any of the cation-containing surfactant mentioned above.

In one or more embodiments, the scale inhibitor fluid may comprise the cation-containing surfactant in an amount ranging from about 20 ppm to 400 ppm, such as a lower limit selected from any one of 20, 25 and 30 ppm to an upper limit selected from any one of 40, 50, 60, 70, 80, 90 100, 150, 200, 250, 300, 350 and 400 ppm, where any lower limit may be paired with any upper limit.

In one or more embodiments, the scale inhibitor fluid may comprise the phosphonate compound and cation-containing surfactant such that the ratio of the cation-containing surfactant to the phosphonate compound, based on ppm, ranges from about 0.5 to 100, such as a lower limit selected from any one of 0.5, 1, 2, 3, and 4 to an upper limit selected from any one of 6, 7, 8, 9, 10, 25, 50, and 100, where any lower limit may be paired with any upper limit.

### Aqueous Fluid

In one or more embodiments, the scale inhibitor fluid may comprise an aqueous fluid. The aqueous fluid may be any fluid that contains water and that may be mixed with the phosphonate compound and the cation-containing surfactant. In one or more embodiments, the aqueous fluid may be a reservoir or formation fluid, or fluid in the formation, which may contain ions, such as calcium, magnesium, carbonate and sulfate ions, capable of forming precipitates. The aqueous fluid may further contain sodium chloride and other substances commonly found in the reservoir fluid.

In one or more embodiments, the aqueous fluid may be a fluid introduced into the wellbore during the oil and gas extraction operation, such as a drilling fluid or an injection fluid. Such fluid introduced into the wellbore may contain ions, such as sulfate ions, capable of forming precipitates, sodium chloride and other additives conventionally used in oil and gas extraction operation, such as the additives described in the below section.

In one or more embodiments, the aqueous fluid may be a mixture of the aforementioned reservoir fluid and the fluid introduced into the wellbore. In such a mixture, various ions from different fluids may react upon mixing, increasing the likelihood of scale formation.

In one or more embodiments, the aqueous fluid may contain calcium ions in an amount of about 2000 ppm or more, such as at least 2000, 4000, 6000, 8000, and 10000 ppm.

In one or more embodiments, the aqueous fluid main contain sulfate ions in an amount of about 2000 ppm or more, such as at least 2000, 4000, 6000, 8000, and 10000 ppm.

In one or more embodiments, the aqueous fluid may contain additives which may include, but are not limited to, barium sulfate, calcium carbonate, thickeners, viscosity modifiers, lubricants, shale inhibitors, weighting agents, deflocculants, emulsifiers and the like.

### Scale Inhibition Ratio

In one or more embodiments, the scale inhibitor fluid provides improved scale inhibition properties when compared to a fluid containing conventional scale inhibitors. Such improvement of scale inhibition properties may be characterized by a scale inhibition ratio % and a scale inhibition increase %.

The scale inhibition ratio % represents the ratio of an amount of scale-formable ions which remains as an ion form in the fluid stored under a specific condition, to the total amount of scale-formable ions in the fluid.

Specifically, the scale inhibition ratio % of a fluid is determined by introducing 4000 ppm of calcium ions and 4000 ppm of sulfate ions to the fluid, storing the fluid at 105° C. for 24 hours in a sealed state to heat treat the fluid, obtaining the amount of calcium ion in the fluid after the heat treatment, and calculating the ratio of the amount of calcium ion in the fluid before and after the heat treatment. The amount of calcium ion in the fluid may be obtained by using equipment such as an inductively coupled plasma mass spectrometer (ICP-MS). The scale inhibition ratio % may be represented by the following formula:

$$Scale inhibition ratio \% = \frac{{m}_{f}}{{m}_{i}} \times 100$$

where m_{f} represents the concentration of calcium ions in the fluid after the heat treatment, and mi represents the concentration of calcium ions in the fluid before the heat treatment. A scale inhibition increase % of the scale inhibitor fluid is a difference of a scale inhibition ratio % of a scale inhibitor fluid and a scale inhibition ratio % of a baseline fluid. The baseline fluid is defined as a fluid identical to the scale inhibitor fluid except that the fluid does not contain the cation-containing surfactant.

In one or more embodiments, the scale inhibition increase % of the scale inhibitor fluid may be about 5% or higher, such as at least 5%, at least 10%, at least 15%, at least 20%, at least 24%, at least 25%, or at least 30%. In one or more embodiments, the scale inhibition increase % of the scale inhibitor fluid may be at least 20%, at least 24%, or at least 25%, when the cationic-containing surfactant is a double positively charged cation-containing surfactant. In one or more embodiments, the scale inhibition increase % of the scale inhibitor fluid may be at least 25%, or at least 30%, when the cationic-containing surfactant is a zwitterionic cation-containing surfactant.

### Method for Inhibiting Scale Formation

In one aspect, embodiments herein relate to a method for inhibiting scale formation in a wellbore. In one or more embodiments, the method may include introducing a phosphonate compound, a cation-containing surfactant and an aqueous fluid to the wellbore to produce a scale inhibitor fluid. The scale inhibitor fluid is produced when the phosphonate compound, cation-containing surfactant and aqueous fluid are combined together, either prior to being introduced to the wellbore, or in the wellbore.

In one or more embodiments, the introduction of the phosphonate compound, the cation-containing surfactant and the aqueous fluid to the wellbore may be conducted separately. In one or more embodiments, the aqueous fluid may be introduced to the wellbore followed by the phosphonate compound and finally, the cation-containing surfactant. In one or more embodiments, the aqueous fluid may be introduced to the wellbore, followed by the cation-containing surfactant and finally, the phosphonate compound.

In one or more embodiments, the aqueous fluid and phosphonate compound may be mixed prior to being introduced to the wellbore. The mixture of the aqueous fluid and phosphonate compound may then be introduced to the wellbore, followed by the introduction of cation-containing surfactant. In one or more embodiments, the aqueous fluid and cation-containing surfactant may be mixed prior to being introduced to the wellbore. The mixture of aqueous fluid and the cation-containing surfactant may then be introduced to the wellbore, followed by the introduction of phosphonate compound. In one or more embodiments, the aqueous fluid may be introduced to the wellbore, followed by the simultaneous introduction of the phosphonate compound and cation-containing surfactant to the wellbore.

In one or more embodiments, the aqueous fluid, phosphonate compound and cation-containing surfactant may be mixed prior to being introduced to the wellbore. In one or more embodiments, the aqueous fluid, phosphonate compound and cation-containing surfactant are not mixed prior to being introduced to the wellbore, but may be introduced to the wellbore simultaneously.

In one or more embodiments, the method may include introducing the phosphonate compound, cation-containing surfactant and aqueous fluid to the wellbore in amounts such that a concentration of the phosphonate compound in the scale inhibitor fluid ranges from 0.001 ppm to 100 ppm, and a concentration of the cation-containing surfactant in the scale inhibitor fluid ranges from 20 ppm to 400 ppm.

In one or more embodiments, the method may further include maintaining the concentration of the phosphonate compound in the scale inhibitor fluid ranges from 0.001 ppm to 100 ppm, and the concentration of the cation-containing surfactant ranges from 20 ppm to 400 ppm entire duration of the oil and gas extraction operation. The concentrations of the phosphonate compound and the cation-containing surfactant may be maintained by additionally introducing the phosphonate compound and/or the cation-containing surfactant to the wellbore. The additional introduction of the phosphonate compound and/or the cation-containing surfactant may be conducted continuously, or intermittently. There is no limitation on the amount or the frequency of the additional introduction, provided that the aforementioned concentration of the phosphonate compound and the cation-containing surfactant are maintained.

### EXAMPLES

The following examples are provided to illustrate embodiments of the present disclosure. The Examples are not intended to limit the scope of the present invention, and they should not be so interpreted.

### Example 1

An exemplary scale inhibitor fluid was prepared by first mixing equal amounts of 4% NaCl solution containing 8000 ppm calcium ions and 4% NaCl solution containing 8000 ppm sulphate solution, and then adding appropriate amounts amino trimethylene phosphonic acid (ATMP) and dodecyltrimethylammonium bromide (DTAB, C₁₂N⁺(CH₃)₃·Br⁻) such that the concentrations of calcium ions, sulphate ions, ATMP and DTAB in the exemplary scale inhibitor fluid were 4000 ppm, 4000 ppm, 40 ppm and 20 ppm, respectively. The scale inhibitor fluid was placed in a sealed bottle and stored at 105° C. for 24 hours. The sample was then analyzed for calcium ion concentration using inductively coupled plasma mass spectrometer (ICP-MS), and the scale inhibition ratio of calcium sulfate was calculated based on the measured calcium ion concentration and the equation provided in the previous section.

### Example 2

A scale inhibitor fluid was prepared according to EXAMPLE 1 except that the amount of added DTAB was varied such that the DTAB concentration was 40 ppm.

### Example 3

A scale inhibitor fluid was prepared according to EXAMPLE 1 except that the amount of added DTAB was varied such that the DTAB concentration was 80 ppm.

### Example 4

A scale inhibitor fluid was prepared according to EXAMPLE 1 except that the amount of added DTAB was varied such that the DTAB concentration was 200 ppm.

### Example 5

A scale inhibitor fluid was prepared according to EXAMPLE 1 except that the amount of added DTAB was varied such that the DTAB concentration was 400 ppm.

### Example 6

A scale inhibitor fluid was prepared according to EXAMPLE 1 except that DTAB was replaced with cetyltrimethylammonium bromide (CTAB, C₁₆N⁺(CH₃)₃·Br⁻). The concentration of CTAB in the fluid was adjusted to be 40 ppm.

### Example 7

A scale inhibitor fluid was prepared according to EXAMPLE 1 except that DTAB was replaced with a double positively charged cation-containing surfactant having a structure C₁₈N+(CH₃)₂—CH₂—CH(OH)—CH₂—N⁺(CH₃)₂·2Cl (BCS). The concentration of BCS in the fluid was adjusted to be 40 ppm.

### Example 8

A scale inhibitor fluid was prepared according to EXAMPLE 1 except that DTAB was replaced with SB3-14. The concentration of SB3-14 in the fluid was adjusted to be 40 ppm.

### Example 9

A scale inhibitor fluid was prepared according to EXAMPLE 1 except that DTAB was replaced with SB3-14. The concentration of SB3-14 in the fluid was adjusted to be 80 ppm.

### Example 10

A scale inhibitor fluid was prepared according to EXAMPLE 1 except that DTAB was replaced with SB3-14. The concentration of SB3-14 in the fluid was adjusted to be 200 ppm.

### Example 11

A scale inhibitor fluid was prepared according to EXAMPLE 1 except that DTAB was replaced with SB3-14. The concentration of SB3-14 in the fluid was adjusted to be 400 ppm.

### Example 12

A scale inhibitor fluid was prepared according to EXAMPLE 6 except that DTAB was further added to the fluid. The concentration of CTAB and DTAB in the fluid were adjusted to be 40 ppm and 10 ppm, respectively.

### Comparative Example 1

A comparative example was prepared according to the method provided in EXAMPLE 1 except no DTAB was added.

### Evaluation-Scale Inhibition Ratio %

The scale inhibition ratios of EXAMPLE 1-12 and COMPARATIVE EXAMPLE 1, and the scale inhibition increase %, using COMPARATIVE EXAMPLE 1 as a baseline fluid, were determined as described in the previous sections.

The scale inhibition ratios of EXAMPLES 1-12 and COMPARATIVE EXAMPLE 1 is shown in Table 1. Table 1 shows that the fluid of COMPARATIVE EXAMPLE 1, which contains 40 ppm ATMP and does not contain cation-containing surfactant, resulted in a scale inhibition ratio of 67.4%. Scale formation was also observed in the fluid of COMPARATIVE EXAMPLE 1. Table 1 further illustrates that by combining the same amount of ATMP as COMPARATIVE EXAMPLE 1 with various cationic-containing surfactants, the scale inhibition ratio % and scale inhibition increase % may be substantially improved. The scale inhibitor fluids of EXAMPLE 1-12 did not show visible scale formation, indicating that combination of phosphonate compound and cation-containing surfactant in the exemplary scale inhibitor fluids provide effective scale inhibition properties.

EXAMPLES 1-5, which include 40 ppm of ATMP combined with DTAB having a concentration of 20 ppm to 400 ppm, provided substantially improved scale inhibition %, demonstrating the effective range of single positively charged cation-containing surfactant concentration in the scale inhibiting fluid. EXAMPLES 8-11, which includes 40 ppm of ATMP combined with SB3-14 having a concentration of 40 ppm to 400 ppm, show that the scale inhibition ratio is 100% in the entire range, illustrating the effectiveness of a zwitterionic cation-containing surfactant in the scale inhibiting fluid in the above range. Furthermore, the scale inhibition ratio % of EXAMPLE 6 and EXAMPLE 12 indicates that a combination of single and double positively charged cation-containing surfactant may provide enhanced scale inhibition properties.

TABLE 1

| | Phosphonate | Cation-containing | Scale Inhibition | Scale Inhibition |
|---|---|---|---|---|
| | Compound | Inhibitor | Ratio (%) | Increase (%) |
| COMPARATIVE | 40 ppm | 0 ppm | 67.4 | N/A |
| EXAMPLE 1 | ATMP | | | |
| EXAMPLE 1 | | 20 ppm DTAB | 100 | 32.6 |
| EXAMPLE 2 | | 40 ppm DTAB | 100 | 32.6 |
| EXAMPLE 3 | | 80 ppm DTAB | 100 | 32.6 |
| EXAMPLE 4 | | 200 ppm DTAB | 96 | 28.6 |
| EXAMPLE 5 | | 400 ppm DTAB | 94.4 | 27 |
| EXAMPLE 6 | | 40 ppm CTAB | 76 | 8.6 |
| EXAMPLE 7 | | 40 ppm BCS | 92 | 24.6 |
| EXAMPLE 8 | | 40 ppm SB3-14 | 100 | 32.6 |
| EXAMPLE 9 | | 80 ppm SB3-14 | 100 | 32.6 |
| EXAMPLE 10 | | 200 ppm SB3-14 | 100 | 32.6 |
| EXAMPLE 11 | | 400 ppm SB3-14 | 100 | 32.6 |
| EXAMPLE 12 | | 40 ppm CTAB, | 90 | 22.6 |
| | | 10 ppm DTAB | | |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

1.-9. (canceled)

10. A method for inhibiting scale formation in a wellbore, the method comprising:
introducing a phosphonate compound, a cation-containing surfactant and an aqueous fluid to the wellbore to produce a scale inhibitor fluid;
wherein:
a concentration of the phosphonate compound in the scale inhibitor fluid ranges from 0.001 ppm to 100 ppm,
a concentration of the cation-containing surfactant in the scale inhibitor fluid ranges from 20 ppm to 400 ppm, and
the cation-containing surfactant comprises at least one of a single positively charged cation-containing surfactant, a double positively charged cation-containing surfactant and a zwitterionic cation-containing surfactant.

11. The method of claim 10, wherein the phosphonate compound comprises a nitrogen-containing phosphonate compound.

12. The method of claim 11, wherein the nitrogen-containing phosphonate compound comprises at least one of amino trimethylene phosphonic acid (ATMP), diethylene triamine penta(methylene phosphonic acid) (DETPMP), bis(hexamethylene triamine penta(methylene phosphonic acid) (BHMT), and hydroxyethylamino-di(methylene phosphonic acid) (MEA).

13. The method of claim 10, wherein the phosphonate compound comprises at least one of C—PO(OH)₂ group and C—PO(OR)₂ group, where R is alkyl or aryl group.

14. The method of claim 10, wherein a scale inhibition increase % of the scale inhibitor fluid is at least 5% at a temperature of 105° C.

15. The method of claim 10, wherein the cation-containing surfactant is the double positively charged cation-containing surfactant.

16. The method of claim 15, wherein a scale inhibition increase % of the scale inhibitor fluid is at least 24% at a temperature of 105° C.

17. The method of claim 10,
wherein the cation-containing surfactant is the zwitterionic cation-containing surfactant, and
wherein the concentration of the cation-containing surfactant in the scale inhibitor fluid is in a range of 40 ppm to 400 ppm.

18. The method of claim 17, wherein a scale inhibition increase % of the scale inhibitor fluid is at least 30% at a temperature of 105° C.
